(19) United States
(12) Patent Application Publication
(10) Pub. No.: US 2007/0209105 A1
(43) Pub. Date: Sep. 13, 2007

(54) MIXING DEVICE FOR TUB

(76) Inventor: Masatoshi MASUDA, Kyoto-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/683,376

(22) Filed: Mar. 7, 2007

(30) Foreign Application Priority Data
Mar. 7, 2006 (JP) 2006-060967
Oct. 6, 2006 (JP) 2006-275039

(51) Int. Cl. A61H 33/02

(52) U.S. Cl. 4/541.4

(57) ABSTRACT

A mixing device for a tub for supplying to a tub a mixed liquid which has mixed gas and water includes: a 1^{st} mixing tub which includes: a chamber with a port which connects to an inlet pipe of the mixed liquid at the top of the chamber, and a cylinder disposed within the chamber and having an upper end opening which connects to an outlet pipe of the mixed liquid and a lower end opening placed in the vicinity of a bottom of the chamber; and a 2^{nd} mixing tub connecting to a flow inlet for supplying the mixed liquid to the inside of the tub and including a supply pipe with multiple holes or bores for the flowing out of the mixed liquid to the mixed liquid which has accumulated inside 2^{nd} mixing tub.

### BACKGROUND OF THE INVENTION

1. Field of the Invention

This invention is related to a mixing device for a tub which mixes gas and liquid in order to supply a tub.

2. Description of the Related Art

The device disclosed in Japanese Patent Laid-open No. 2001-145676 (patent citation 1) is known as a device which mixes gas and liquid in order to supply a tub in which a warm bath effect is obtained for limbs in liquid with dissolved gas such as carbon dioxide.

The device disclosed in patent citation 1, provides a tub, a jet nozzle which sprays a jet flow to the tub, and an air intake which connects to the jet nozzle through an air flow pipe.

As a result of this construction, according to the device disclosed in patent citation 1, it is possible to supply liquid which has been mixed with gas to a tub, and it is possible to enhance the effect of a warm bath.

However, according to the device disclosed in patent citation 1, because there is simply only the supply of gas through the air flow pipe to the liquid which is to be supplied to the tub, it is not possible to mix enough gas. If it is not possible to mix enough gas, the gas from the liquid which was mixed in the tub will immediately flow out.

### SUMMARY OF THE INVENTION

This invention has been made to solve at least this sufficiency problem, having as a goal to supply a mixing device for a tub which provides a mixing structure for supplying sufficient gas to liquid which is supplied, in turn, to a tub.

In a first embodiment, the present invention provides a mixing device for a tub which supplies to a tub a mixed liquid which has mixed gas and water, characterized by comprising: (a) a 1^{st} mixing tub comprising: (i) a chamber with a hole which connects to an inlet pipe of the mixed liquid at the top of the chamber, and (ii) a cylinder disposed within the chamber and having an upper end opening which connects to an outlet pipe of the mixed liquid and a lower end opening placed in the vicinity of a bottom of the chamber; (b) a 2^{nd} mixing tub connecting to a flow inlet which supplies the mixed liquid to the inside of the tub, said 2^{nd} mixing tub comprising a supply pipe with multiple holes or bores (e.g., more than 100 holes or bores arranged substantially or nearly uniformly along the circumference) for the flowing out of the mixed liquid to the mixed liquid which has accumulated inside 2^{nd} mixing tub; (c) an intermediate supply path for supplying the mixed liquid to the 2^{nd} mixing tub from the 1^{st} mixing tub; (d) a supply path for supplying the mixed liquid to the tub from the 2^{nd} mixing tub; (e) a recovery circulating path for recovery of the mixed liquid in the tub to the 1^{st} mixing tub; (f) a water supply which supplies water to a circulating path which reaches the tub via the 1^{st} and 2^{nd} mixing tubs from the recovery circulating path; and (g) a gas supply which supplies gas to the circulating path which reaches the tub via the 1^{st} and 2^{nd} mixing tubs from the recovery circulating path.

A second embodiment provides an open-closed valve in the intermediate supply path or the 2^{nd} mixing tub in the mixing device for a tub in the first embodiment.

A third embodiment provides, for the mixing device for a tub in the first or second embodiment, a counter flow wall for making collide in the 2^{nd} mixing tub water flow of the mixed liquid introduced accumulated in the 2^{nd} mixing tub.

A fourth embodiment has, for the mixing device for a tub in any of the first to third embodiments, the supply pipe connected to the liquid inlet from the intermediate supply path.

A fifth embodiment has, for the mixing device for a tub in any of the first to third embodiments, the 2^{nd} mixing tub provided with a circulating pump, a flow path for flowing the mixed liquid which accumulated in the 2^{nd} mixing tub by the circulation pump, and a flow out path for flowing out of the mixed liquid to the 2^{nd} mixing tub from the circulation pump, wherein the supply pipe is connected to the flow out path.

A sixth embodiment, for the mixing device for a tub in any of the first to fifth embodiments, has the supply pipe which supplies to a shower-shape object the mixed liquid to inside the 2^{nd} mixing tub through the multiple holes which are immersed with the mixed liquid.

A seventh embodiment, for the mixing device for a tub in any of the first to fifth embodiments, has the supply path which supplied to a shower-shape object the mixed liquid in the 2^{nd} mixing tub through the multiple holes which are disposed above the liquid surface of the mixed liquid.

A eighth embodiment, for the mixing device for a tub in any of the first to seventh embodiments, has, as the gas that is supplied by the gas supply section, carbon dioxide.

According to the first embodiment, it is possible to supply a mixture of liquid and gas to a tub.

According to the second embodiment, there can be promotion of the dissolution of the gas within mixed liquid by providing an open-closed valve in the intermediate supply path.

According to the third embodiment, it is possible to sufficiently mix and dissolve the gas in the mixed liquid within the 2^{nd} mixing tub by providing a counter flow wall for making collide the water flow of the mixed liquid which has accumulated in the 2^{nd} mixing tub and inducing the counter flow of the mixed liquid within the 2^{nd} mixing tub.

According to the fourth embodiment, because the supply pipe of the 2^{nd} mixing tub is connected to the flow inlet from the intermediate supply path, when supplying the mixed liquid to within the 2^{nd} mixing tub, it becomes possible to elevate the dissolution of the gas.

According to the fifth embodiment, it is possible to further dissolve the gas in the mixed liquid which has accumulated within the 2^{nd} mixing tub.

According to the sixth embodiment, within the 2^{nd} mixing tub, because the supply pipe supplies to a shower-shape object the mixed liquid within the 2^{nd} mixing tub by means of multiple holes which have been immersed in the mixed liquid, multiple counter flows within the 2^{nd} mixing tub are generated, and it becomes possible to elevate the dissolution efficiency of the gas within the 2^{nd} mixing tub.

According to the seventh embodiment, within the 2^{nd} mixing tub, because the supply path supplies to a shower-shape object the mixed liquid within the 2^{nd} mixing tub by means of multiple holes which are disposed as multiple holes on top of the liquid surface of the mixed liquid, it becomes possible to elevate the dissolution in the mixed liquid gas which accumulated within the 2^{nd} mixing tub.

According to the eighth embodiment, because the gas which is supplied from the gas supply section is carbon dioxide, it becomes possible to promote vascular movement within the tub occupant's body.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 is a perspective diagram of tub 3 which appropriately uses the mixing device for a tub 1 which is related to Embodiment 1 of this invention.

FIG. 2 is a diagram which schematically shows the flow of the water and gas of the mixing device for a tub 1 which is related to Embodiment 1 of this invention.

FIG. 3 is an explanatory diagram which illustrates the 1^{st} mixing tub 10 which forms the mixing device for a tub 1 which is related to Embodiment 1 of this invention.

FIG. 4 is an explanatory diagram which illustrates the 2^{nd} mixing tub 20 which forms the mixing device for a tub 1 which is related to Embodiment 1 of this invention.

FIG. 5 is a partial section view which illustrates from the side the supply pipe 220 which is provided to the 2^{nd} mixing tub 20 which forms the mixing device for a tub 1 which is related to Embodiment 1.

FIG. 6 is an explanatory diagram which illustrates the periphery of the 2^{nd} mixing tub 20 which forms the mixing device for a tub 1 which is related to Embodiment 2 of this invention.

FIG. 7 is an explanatory diagram which illustrates the periphery of the 2^{nd} mixing tub 20 which forms the mixing device for a tub 1 which is related to Embodiment 3 of this invention.

FIG. 8 is an explanatory diagram which illustrates the periphery of the 2^{nd} mixing tub 20 which forms the mixing device for a tub 1 which is related to Embodiment 4 of this invention.

FIG. 9 is an explanatory diagram which illustrates the periphery of the 2^{nd} mixing tub 20 which forms the mixing device for a tub 1 which is related to Embodiment 5 of this invention.

FIG. 10 is an explanatory diagram which illustrates the periphery of the 2^{nd} mixing tub 20 which forms the mixing device for a tub 1 which is related to Embodiment 6 of this invention.

### EXPLANATION OF THE ELEMENTS

1—mixing device for a tub

3—tub

10—1^{st} mixing tub

11—container

12—cover member

12a—flow-in hole

12b—flow-out hole

13—cylinder-shaped body

13a—lower end opening

13b—upper end opening

20—2^{nd} mixing tub

21—open-close valve

23—backflow wall

24—circulating pump

25—flow-in path

26—flow-out path

31—supply path

32—recovery circulating path

33—flow path

34—intermediate supply path

35—flow path

36—discharge water path

41—water supply section

42—gas supply section

43—pump

51—open-close valve

61—open-close valve

62—open-close valve

63—switching valve

220—supply pipe

230—supply pipe

240—supply pipe

221—hole

222—opening

301—tub for limbs (arms)

302—tub for legs

303—column, post

310—long chair

### DETAILED DESCRIPTION OF THE PREFERRED EMBODIMENT

The present invention will be explained with reference to preferred embodiments and drawings. However, the preferred embodiments and drawings are not intended to limit the present invention.

The present invention is described by referring to figures. Additionally, “the present invention” aims to mean “an embodiment of the present invention”, but “an embodiment of the present invention” does not aim to limit the present invention thereby.

In the present disclosure where conditions and/or structures are not specified, the skilled artisan in the art can readily provide such conditions and/or structures, in view of the present disclosure, as a matter of routine experimentation.

Hereafter there is an explanation of implementations of this invention, based on the included drawings.

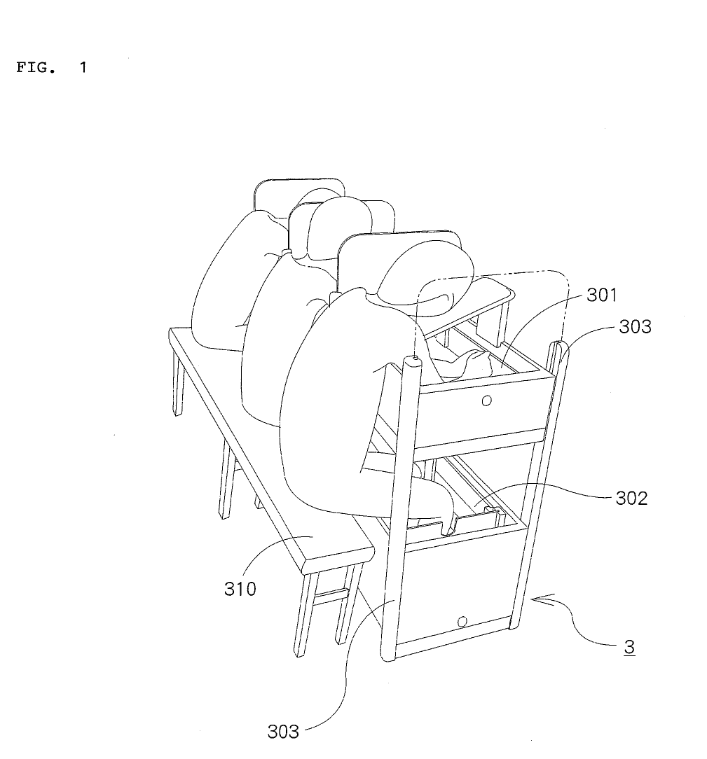

FIG. 1 is a perspective view which shows the tub 3 which is appropriate to use for the mixing device for a tub which is related to embodiment 1 of this invention.

This tub 3 is comprised of the tub for arms 301 and the tub for legs 302, with both tubs connected in the up and down direction by the columns 303. The user is seated at a long chair 310 which is arranged in front of the tub 3, and by immersing his arms and legs in the tub for arms 301 and the tub for legs 302, it is possible to locally promote blood circulation within the body.

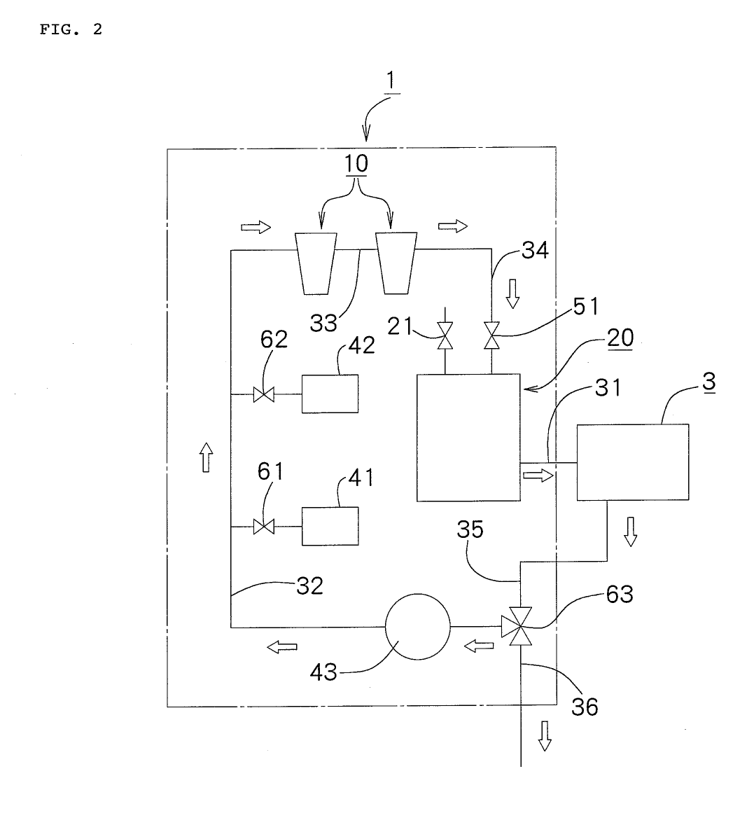

FIG. 2 is a diagram which shows schematically the flow of gas and liquid of the mixing device 1 which is necessary for Embodiment 1 of this invention.

The mixed liquid which has been mixed with gas by this mixing device for a tub is supplied to the tub 3 by means of the supply path 31. The mixed liquid which flows out from the tub 3 circulates within the mixing device for a tub through the use of a pump 43 which is provided by the mixing device for a tub 1 through the flow path 35, and once again is supplied to the tub 3.

This mixing device for a tub provides a pair of 1^{st} mixing tubs 10, a 2^{nd} mixing tub 20, a supply path 31 to the tub 3, a recovery circulating path 32 which reaches as far as the 1^{st} mixing tub from the tub 3, a water supply section 41 which supplies water to the recovery circulating path 32, a gas supply section 42 which supplies gas to the recovery circulating path 32, and a pump 43 for circulating the mixed liquid within the mixing device for a tub 1.

The water supply section 41 provides a water supply mechanism for supplying water to the recovery circulation section 32. An open-close valve 61 is provided in the connection pipe between the water supply section 41 and the recovery circulating path 32. It is possible to adjust the water supply amount. With this ability to regulate the amount of water, and from considerations of the amount of water which circulates within the mixing device for a tub and accumulates in the tub 3, it becomes possible to appropriately supply the necessary amount of water.

The gas supply section 42 provides a mechanism which supplies gas for enhancing the bath, such as carbon dioxide, to the recovery circulating path 32. An open-close valve 62 is provided within the connection pipe between the gas supply section 42 and the recovery circulating path 32, and with this valve, it becomes possible to adjust the amount of gas which is supplied to the water which circulates within the mixing device for a tub 1 and accumulates in the tub 3. In addition, by connecting the gas supply section 42 to the recovery circulating path 32, the gas separates from the mixed liquid, which was supplied to the tub 3, whose top part is open to the atmosphere. The gas dissolution of the mixed liquid can be reduced, but it becomes possible to replenish with new gas as far as the 1^{st} mixing tub 10 by means of the recovery circulating path 32.

A switching valve 63 is provided between the flow path 35 from the tub 3 and the recovery circulating path 32 for switching the flow path of the mixed liquid which flows out from the tub 3. With this valve, it becomes possible to directly discharge water from the tub 3.

The 1^{st} mixing tub 10 and the 2^{nd} mixing tub 20 are serially connected to the flow path from the recovery circulating path 32 to the tub 3.

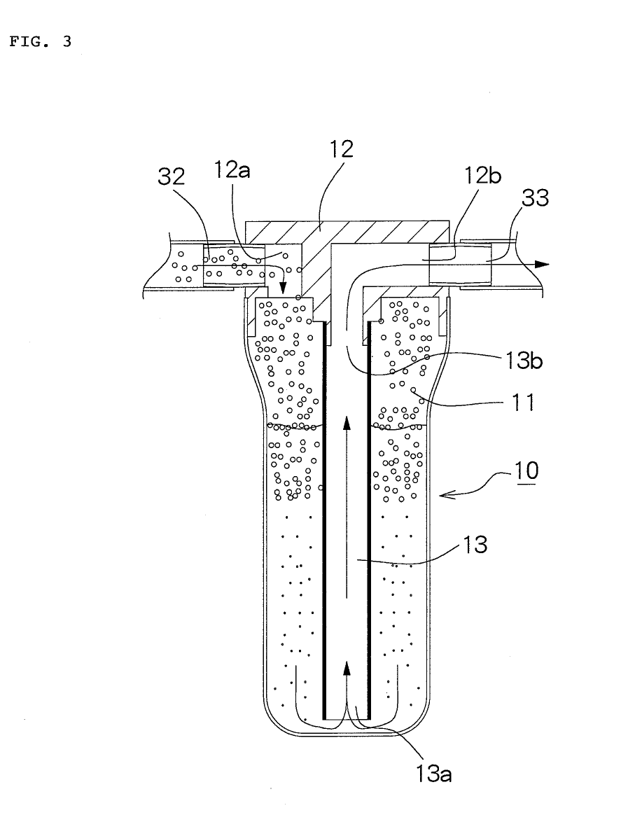

FIG. 3 is an explanatory diagram illustrating the 1^{st} mixing tub 10 which forms this mixing device for the tub 1.

The 1^{st} mixing tub 10 provides a cylinder-shaped container which has an opening on top, cover member 12 for closing the opening of the container 11, and a cylinder-shaped body 13 which is established within the container 11. The cover member 12 is formed from the flow-in hole 12a which is inserted into the container 11, connecting to the circulating supply path 32, and from the flow-out hole 12b which is inserted into the container 11, connecting to the flow path 33. The cylinder-shaped body 13 has a lower end opening 13a, which is disposed close to the base of the container 11, and an upper end opening 13b, both of which are connected to the flow path 33 by means of the flow-out hole 12b of the cover member 12.

Because of this arrangement, the mixed liquid which is supplied from the recovery circulating path 32 becomes discharged to the flow path 33 after reaching the base of the container 11. By this discharge and from the difference in specific gravity between the liquid and gas, a backflow is generated within the container 11 by liquid flow which is supplied from the gas flow, which rises, and the recovery circulating path 32. It becomes possible to dissolve to an appropriate degree the gas in the liquid.

The flow path 33 is further connected to the 1^{st} mixing tub, and the mixed liquid passes through the same process previously described and flows into the intermediate circulating path 34.

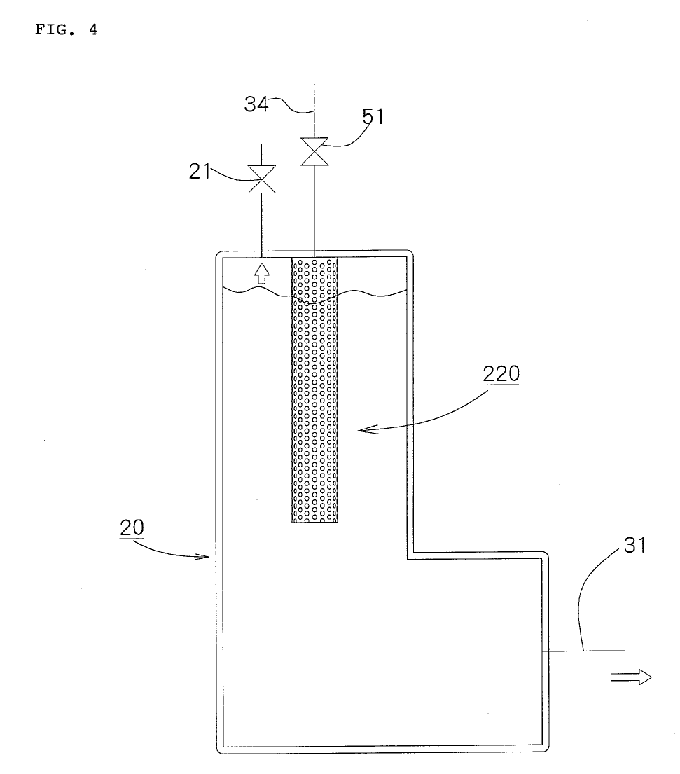

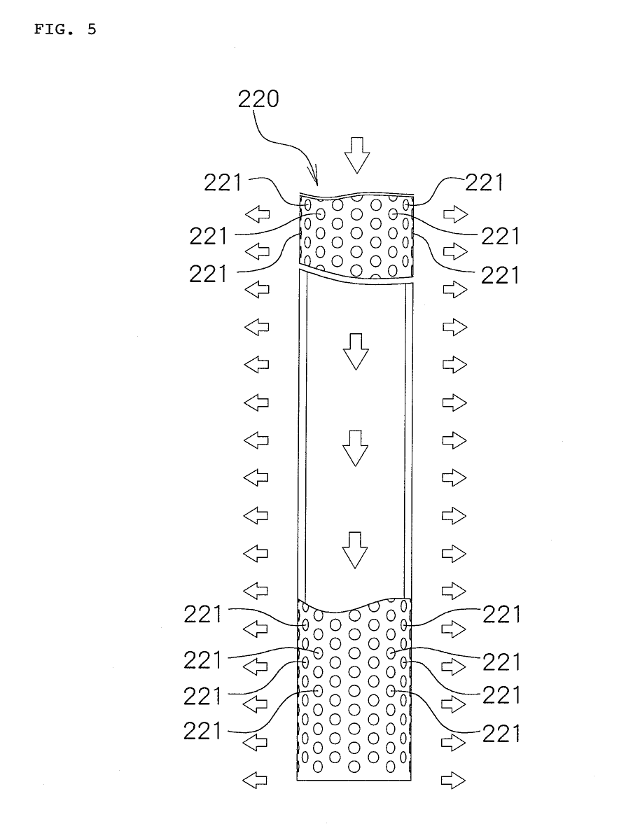

FIG. 4 is an explanatory diagram which illustrates the 2^{nd} mixing tub 20 which forms this mixing device for a tub 1. FIG. 5 is a partial sectional diagram which illustrates, from a side surface the supply pipe 220 which is provided to this 2^{nd} mixing tub 20.

This 2^{nd} mixing tub 20 has an L-shape and provides a supply pipe 220, as shown in FIG. 5. The supply pipe 220 is connected to the intermediate supply path 34 from the 1^{st} mixing tub 10. The mixed liquid accumulates in the 2^{nd} mixing tub 20 by means of this supply pipe 220.

Multiple holes 221 have been drilled in the supply pipe 220. Through a connection of this supply pipe 220 to the intermediate supply path 34, the mixed liquid is supplied to the 2^{nd} mixing tub 20 by passing through these multiple holes 221 from the intermediate supply path 34. Because of this supply, the mixed liquid is released to the shower-shape object within the mixed liquid which has accumulated in the 2^{nd} mixing tub 20. It becomes possible to enhance the dissolution efficiency of the gas. Because the supply pipe 220 is immersed in mixed liquid at this time, a backflow is generated within the mixed liquid which had accumulated in the 2^{nd} mixing tub 20 through the flowing-out of the liquid from the multiple holes 221. Because of this backflow, it becomes possible to sufficiently dissolve gas in the mixed liquid within the 2^{nd} mixing tub 20.

In addition, the 2^{nd} mixing tub 20 provides an open-close valve 21 for air venting within the 2^{nd} mixing tub 20. The open-close valve 21 is formed to release when supplying the mixed liquid to the tub 3 from the 2^{nd} mixing tub 20, and when supplying the mixed liquid to the tub 3 from the 2^{nd} mixing tub 20, and for preventing contact of the mixed liquid and outside air within the 2^{nd} mixing tub 20, it is desirable to form the open-close valve so that there is no release. For example, it is good to release the open-close valve 21 only when discharging liquid which is accumulating within the 2^{nd} mixing tub 20 or the tub 3.

Moreover, there is provided an open-close valve 51 in the intermediate supply path 34 from the 1^{st} mixing tub 10 to the 2^{nd} mixing tub 20. It becomes possible, by providing an open-close valve 51 to the intermediate supply path 34, to adjust the force of the mixed liquid within the intermediate supply path 34. While increasing pressure of the mixed liquid within the intermediate supply path by locally narrowing the liquid path of the intermediate supply path 34 and by supplying to the 2^{nd} mixing tub 20, it is possible to promote dissolution of the gas in the mixed liquid, which is not yet saturated with gas.

In addition, the open-close valve 51 may be formed to be included in, in addition to the intermediate supply path 34, the flow path 33.

Mixing the gas and liquid, using this mixing device for a tub 1, is done first by releasing the open-close valve 61 and the open-close valve 62, supplying water to the recovery circulating path 32 by the water supply section 41, and mixing the gas from the gas supply section in this water.

After the water and the gas, which was supplied to the recovery circulating path 32, passes through the mixing process by the pair of 1^{st} mixing tub 10, the gas accumulates in the 2^{nd} mixing tub 20, further mixing and dissolving.

The mixed liquid which has accumulated in the 2^{nd} mixing tub 20 is supplied to the tub 3. If the flow path of the mixed liquid which has flowed-out from the tub 3 is connected to the recovery circulating path 32 by the switching valve 63, circulation occurs within the mixing device for a tub 1, and if connected to the discharge water path 36 by the switching valve 63, the mixed liquid discharges water to the outside of the mixing device for a tub 1.

Moreover, in order to supply continuously to the tub 3 mixed liquid which normally mixes gas, it is desirable to have the connection site towards the recovery circulating path 32 of the gas supply section 42, assuming the site is downstream from the water supply section 41, and be of a construction such that the gas is mixed before the supplied water arrives at the 1^{st} mixing tub 10. However, a construction such that the water supply section 41 is connected to the tub 3 is permissible.

As stated above, with this embodiment, by providing multiple mixing tubs which have identical mixing mechanisms or by providing furthermore assembly of multiple mixing tubs which have different mixing mechanisms, it is possible to supply to the tub 3 mixed liquids in which gases sufficiently dissolve in water.

Moreover, the recovery circulating tub 32 has a construction, in addition to that of the 1^{st} mixing tub 10, which may connect a mixed liquid filtering device and the like.

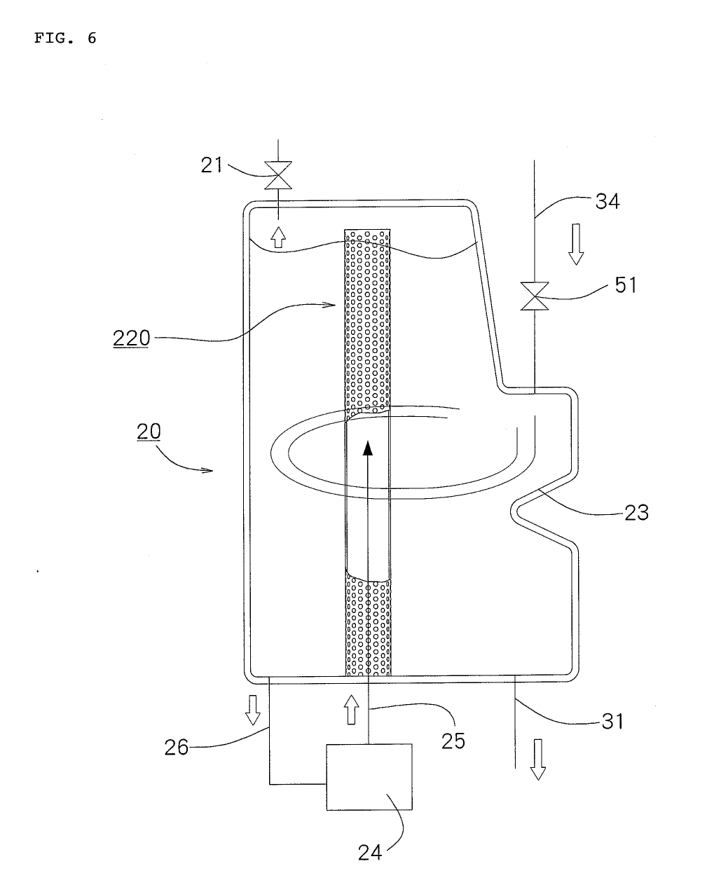

FIG. 6 is an explanatory diagram which illustrates the 2^{nd} mixing tub 20 which forms a mixing device for a tub which is related to Embodiment 2.

This 2^{nd} mixing tub 20 differs from the 2^{nd} mixing tub 20 which formed the mixing device for a tub 1 which is related to Embodiment 1 by having a backflow wall 23 in its interior, providing a re-circulating mixing mechanism which circulates mixed liquid which has accumulated within the 2^{nd} mixing tub 20. That is, the re-circulating mixing mechanism, by using the circulating pump 24, has mixed liquid which flows-out to the circulating pump 24 from the 2^{nd} mixing tub 20 by means of the flow-out path 26, and by means of the supply pipe 220, which is connected to the flow-in path 25 towards the 2^{nd} mixing tub from the circulating pump 24, has a construction which re-supplies within the mixing tub 20. From this kind of structure, it becomes possible to further enhance the dissolution of the gas with the mixed liquid.

In addition, the geometry of this 2^{nd} mixing tub 20 has changed so that one side of its side wall has become a doglegged shape. From this shape change, there results the formation of a backflow wall at a diagonal position with the flow inlet of the mixed liquid from the intermediate supply path 34 within the 2^{nd} mixing tub 20. The water flow of the mixed liquid which has flowed in perpendicularly from the flow inlet towards the 2^{nd} mixing tub 20 changes the direction of this flow by collision with the backflow wall 23, and there occurs backflow for the accumulated mixed liquid within the 2^{nd} mixing tub 20. From this backflow, it becomes possible to further mix the gas into the mixed liquid.

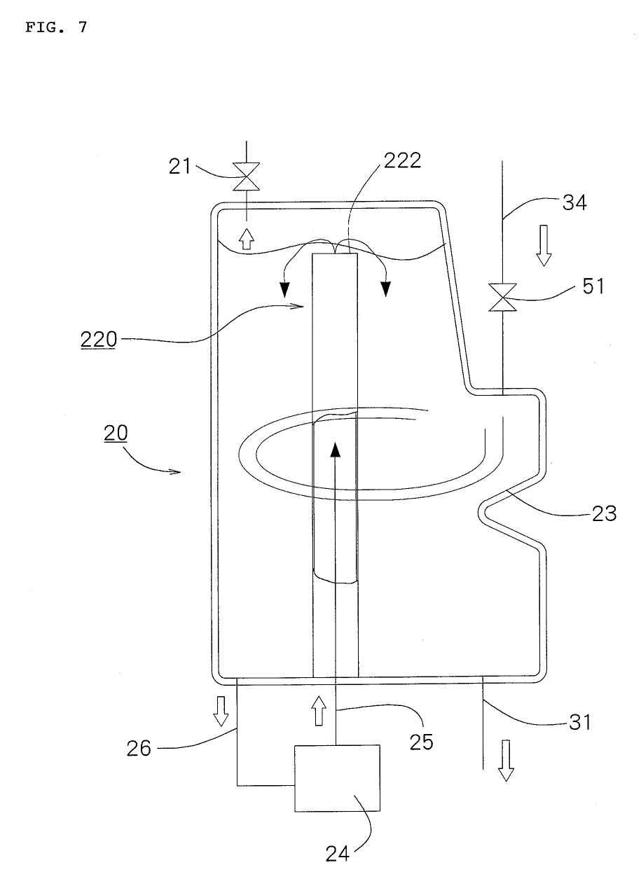

FIG. 7 is an explanatory diagram which illustrates the 2^{nd} mixing tub 20 which formed the mixing device for a tub 1 which is related to Embodiment 3.

This 2^{nd} mixing tub 20 differs from the 2^{nd} mixing tub which formed the mixing device for a tub 1 which is related to Embodiment 2. The holes 221 are not formed on the side peripheral surface of the supply pipe 230 which is provided in the interior of the mixing tub. There is supply of mixed liquid to the 2^{nd} mixing tub 20 for this 2^{nd} mixing tub 20 by the opening 222 at the upper end of the supply pipe 230. This 2^{nd} mixing tub 20 forms multiple holes at the opening 222, and because there results a release of the mixed liquid in a spraying water condition by means of the multiple holes of the opening 222 within the tub, it is possible to enhance the dissolution in the mixed liquid. Moreover, the opening of the supply pipe 230 may be shaped like a nozzle.

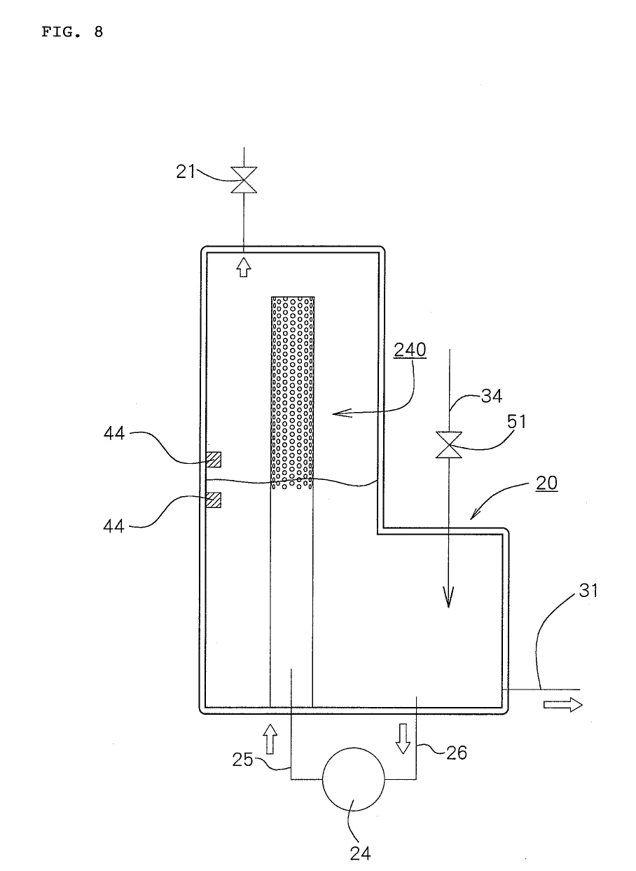

FIG. 8 is an explanatory diagram which illustrates the 2^{nd} mixing tub which forms a mixing device for a tub 1 which is related to Embodiment 4.

This 2^{nd} mixing tub 20 differs from the 2^{nd} mixing tub 2 which forms the mixing device for a tub 1 which is related to Embodiment 2, with no backflow wall 23 in the tub's interior.

In addition, this 2^{nd} mixing tub 20, which is different from the 2^{nd} mixing tub which formed the mixing device for a tub related to Embodiment 2, provides a water level sensor 44 within the mixing tub. Furthermore, the supply pipe 240, which is disposed to the interior, is different from the supply pipe 220, which is disposed within the 2^{nd} mixing tub for Embodiment 2, at points which form the holes 221 at the part which protrudes upward from the water's surface of the mixed liquid of the 2^{nd} mixing tub 20, which is controlled by the water level sensor.

The water level signal which is sensed by the water level sensor 44 is transmitted to the control section (not illustrated). With the water level signal, which is transmitted to the control section, being transmitted to the open-close valve 61 and the open-close valve 62 which convert to a signal which adjusts the degree of opening of the open-close valve 61 and the open-close valve 62 which adjust the supply amount from the water supply section 41 and the gas supply section 42, there is adjustment of the water level within the 2^{nd} mixing tub 20 so that there results a specified level for the water level sensor.

Moreover, when the water level within the 2^{nd} mixing tub 20 exceeds the specified level of the water level sensor, an alarm signal is generated, and in response to this alarm, the operator may adjust the degree of opening by hand of the open-close valve 61 and the open-close valve 62.

Because the 2^{nd} mixing tub 20 which forms the mixing device for a tub 1 which is related to this Embodiment 4 establishes a supply pipe which partially forms holes which protrude upward from the water surface of the mixed liquid of the 2^{nd} mixing tub 20 which is controlled by the water level sensor 44, there results supply to a shower-shaped object of the mixed liquid within the 2^{nd} mixing tub 20 by means of the holes 221 above the water surface of the mixed liquid, thereby making it possible to further dissolve within the mixed liquid gas which accumulates within the 2^{nd} mixing tub.

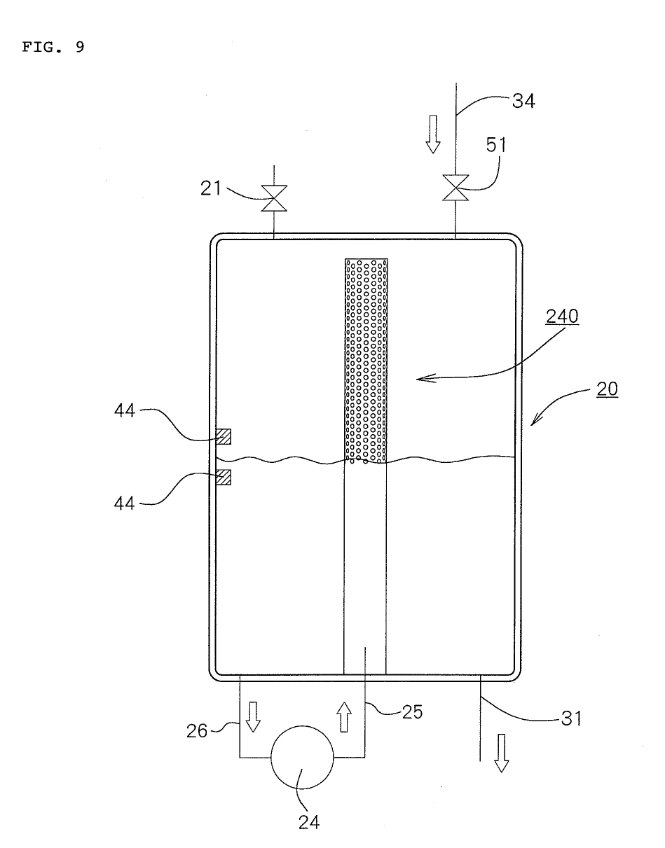

FIG. 9 is an explanatory diagram which illustrates the 2^{nd} mixing tub 20 which forms the mixing device for a tub 1 which is related to Embodiment 5.

This 2^{nd} mixing tub 20 differs from the 2^{nd} mixing tub 20 which forms the mixing device for a tub 1 which is related to Embodiment 4 at points where its vertical cross-section is rectangular.

Moreover, the supply pipe 240 which is established in the 2^{nd} mixing tub 20 which forms the mixing device for a tub 1 which is related to Embodiments 4 and 5 may be the supply pipe 220 which is established in the 2^{nd} mixing tub 20 which forms the mixing device for a tub 1 which is related to Embodiment 2 or may be the supply pipe 230 which is established in the 2^{nd} mixing tub 20 which forms the mixing device for a tub 1 which is related to Embodiment 3. With any of the supply pipes, by spraying the mixed liquid on top of the liquid surface of the mixed liquid, it is possible to further dissolve in the mixed liquid gas which accumulates within the 2^{nd} mixing tub 20.

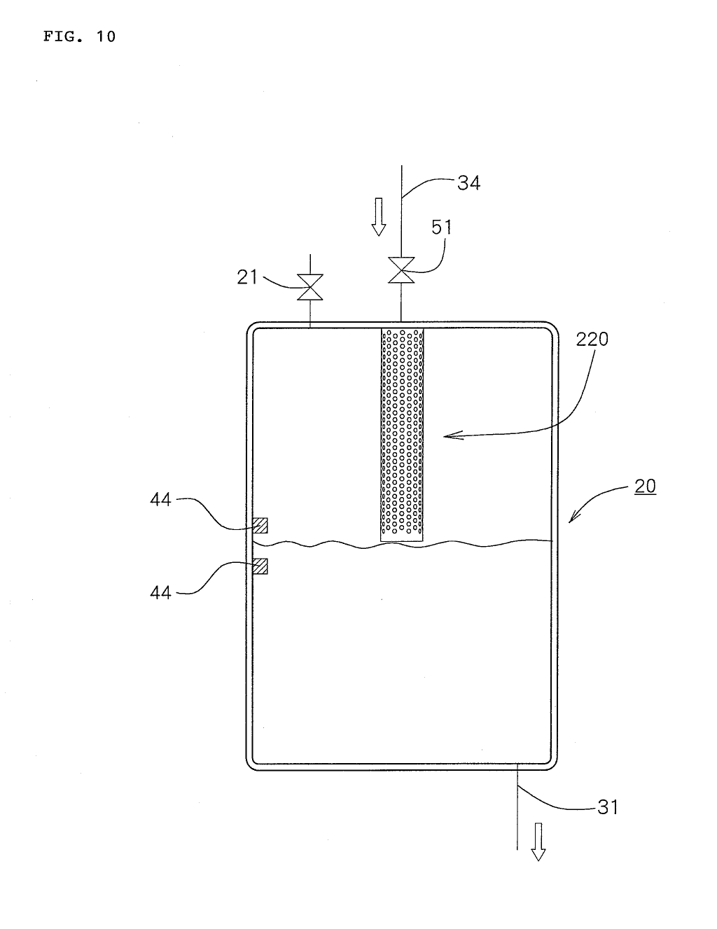

FIG. 10 is an explanatory diagram which illustrates the 2^{nd} mixing tub 20 which forms the mixing device for a tub 1 which is related to Embodiment 6.

This 2^{nd} mixing tub 20 differs from the 2^{nd} mixing tub 20 which forms the mixing device for a tub 1 which is related to Embodiment 5, and does not provide a re-circulating mixing mechanism. In the same way as with the supply pipe 220 which was provided to the 2^{nd} mixing tub 20 which forms the mixing device for a tub 1 which is related to Embodiment 1, the mixed liquid passes through the multiple holes 221 of the supply pipe 220 from the intermediate supply path 34, and being supplied to a shower shaped object, the mixed liquid forms on top of the water surface of the mixed liquid which accumulated in the 2^{nd} mixing tub 20.

In this embodiment, by the above described description, it becomes possible to incorporate mixed liquid which is supplied to the 2^{nd} mixing tub 20 from the intermediate supply path 34 and further incorporate gas which has been accumulating within the 2^{nd} mixing tub 20 within the mixed liquid.

Moreover, in the above described embodiments, for the supply path 31 directed towards the tub 3, a recovery means may be established which recovers by separating from the liquid the gas which has separated from the liquid. It is also permissible to establish a new pipe path so as to lead, once again to the spray outside of the pump 43 of the recovery circulating path 32, gas that has been recovered by this recovery means.

In addition, the 2^{nd} mixing tub 20 which forms the mixing device for a tub 1, with this new pipe path, may be formed so as to connect with the flow-in path 25 to the 2^{nd} mixing tub 20 from the recovery circulating path 32 as in Embodiments 2-5 which are shown in FIGS. 6-9 which provide the re-circulating mixing mechanism.

The present application claims priority to Japanese Patent Application No. 2006-60967, filed Mar. 7, 2006, and No. 2006-275039, filed Oct. 6, 2006, the disclosure of which is incorporated herein by reference in their entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

1. A mixing device for a tub for supplying to a tub a mixed liquid which has mixed gas and water, characterized by comprising:
a 1^{st} mixing tub which comprises:
a chamber with a port which connects to an inlet pipe of the mixed liquid at the top of the chamber, and
a cylinder disposed within the chamber and having an upper end opening which connects to an outlet pipe of the mixed liquid and a lower end opening placed in the vicinity of a bottom of the chamber;
a 2^{nd} mixing tub connecting to a flow inlet for supplying the mixed liquid to the inside of the tub, said 2^{nd} mixing tub comprising a supply pipe with multiple holes or bores for the flowing out of the mixed liquid to the mixed liquid which has accumulated inside 2^{nd} mixing tub;
an intermediate supply path for supplying the mixed liquid to the 2^{nd} mixing tub from the 1^{st} mixing tub;
a supply path for supplying the mixed liquid to the tub from the 2^{nd} mixing tub;
a recovery circulating path for recovery of the mixed liquid in the tub to the 1^{st} mixing tub;
a water supply for supplying water to a circulating path which reaches the tub via the 1^{st} and 2^{nd} mixing tubs from the recovery circulating path; and
a gas supply for supplying gas to the circulating path which reaches the tub via the 1^{st} and 2^{nd} mixing tubs from the recovery circulating path.

2. The mixing device for a tub according to claim 1, wherein an open-closed valve is provided in the 2^{nd} mixing tub.

3. The mixing device for a tub according to claim 1, wherein the 2^{nd} mixing tub is provided with a counter flow wall for making collide in the 2^{nd} mixing tub water flow of the mixed liquid accumulated in the 2^{nd} mixing tub.

4. The mixing device for a tub according to claim 1, wherein the supply pipe is connected to the flow inlet from the intermediate supply path.

5. The mixing device for a tub according to claim 1, wherein the 2^{nd} mixing tub is provided with a circulating pump, a flow path for flowing the mixed liquid which accumulated in the 2^{nd} mixing tub by the circulation pump, and a flow out path for flowing out of the mixed liquid to the 2^{nd} mixing tub from the circulation pump, wherein the supply pipe is connected to the flow out path.

6. The mixing device for a tub according to claim 1, wherein the multiple holes or bores are distributed uniformly in an axial direction of the supply pipe and around the circumference of the supply pipe so that the supply pipe can supply to a shower-shape object the mixed liquid to inside the 2^{nd} mixing tub through the multiple holes or bores which are immersed with the mixed liquid when in use.

7. The mixing device for a tub according to claim 1, wherein the supply pipe has an upper portion and a lower portion and the multiple holes or bores are distributed exclusively around the upper portion so that the supply path can supply to a shower-shape object the mixed liquid in the 2^{nd} mixing tub through the multiple holes or bores which are disposed above a liquid surface of the mixed liquid when in use.

8. The mixing device for a tub according to claim 1, wherein the gas supply section supplies carbon dioxide.

9. The mixing device for a tub according to claim 1 wherein the 1^{st} mixing tub is closed except for the inlet pipe and the outlet pipe.

10. The mixing device for a tub according to claim 1, wherein the 2^{nd} mixing tub is closed except for the flow inlet and a flow outlet connected to the intermediate supply path.

11. The mixing device for a tub according to claim 1, wherein the supply pipe is arranged upright in the 2^{nd} mixing tub.

12. The mixing device for a tub according to claim 5, wherein the multiple holes or bores are distributed uniformly in an axial direction of the supply pipe and around the circumference of the supply pipe, said supply pipe having an upper end disposed in the vicinity of a top of the 2^{nd} mixing tub and extends downward to a lower end connected to the flow out path disposed at a bottom of the 2^{nd} mixing tub.

13. The mixing device for a tub according to claim 5, wherein the multiple holes or bores are distributed exclusively on an upper end of the supply pipe disposed in the vicinity of a top of the 2^{nd} mixing tub, said supply pipe extending downward to a lower end connected to the flow out path disposed at a bottom of the 2^{nd} mixing tub.

14. The mixing device for a tub according to claim 5, wherein the supply pipe has an upper portion and a lower portion connected to the flow out path disposed at a bottom of the 2^{nd} mixing tub, and the multiple holes or bores are distributed exclusively around the upper portion so that the supply path can supply to a shower-shape object the mixed liquid in the 2^{nd} mixing tub through the multiple holes or bores which are disposed above a liquid surface of the mixed liquid in the 2^{nd} mixing tub when in use.

15. The mixing device for a tub according to claim 14, wherein the 2^{nd} mixing tub is provided with a water level sensor for adjusting the liquid surface between the upper portion and the lower portion of the supply pipe.

16. The mixing device for a tub according to claim 15, wherein the flow inlet from the intermediate supply path is connected to the 2^{nd} mixing tub at a position below the water level sensor.

17. The mixing device for a tub according to claim 15, wherein the flow inlet from the intermediate supply path is connected to the 2^{nd} mixing tub at a position above the water level sensor.

18. The mixing device for a tub according to claim 6, wherein the supply pipe has an upper end connected to the flow inlet and extends downward to a lower end arranged away from a bottom of the 2^{nd} mixing tub.

19. The mixing device for a tub according to claim 18, wherein the 2^{nd} mixing tub is provided with a water level sensor for adjusting a liquid surface in the 2^{nd} mixing tub at the lower end of the supply pipe.
